(19) United States
(12) Patent Application Publication
(10) Pub. No.: US 2018/0225476 A1
(43) Pub. Date: Aug. 9, 2018

(54) AUTOMATED IMAGE EDITING SYSTEM

(71) Applicant: SIRACUSANO

(72) Inventor: Louis Siracusano, JR., Northvale, NJ (US)

(21) Appl. No.: 15/424,454

(22) Filed: Feb. 3, 2017

(51) Int. Cl. G06F 21/62; G06K 9/00; G06T 5/00; G06T 11/60; G11B 27/036; G06F 21/31

(52) U.S. Cl. CPC G06F 21/6245; G06K 9/00228; G06K 9/00711; G06T 5/002; G06T 11/60; G11B 27/036; G06K 2209/15; G06F 21/31; G06T 2207/10016; G06T 2207/30204; G06T 2207/30232; G06T 2207/30201; G06K 9/00771

(57) ABSTRACT

A method comprising: detecting a first input selecting a first object in a first video; detecting a second input selecting a second object in the first video; generating a first marking layer based on the first input and the first video, the first marking layer being associated with the first object; generating a second marking layer based on the second input and the first video, the second marking layer being associated with the second object; and generating, by at least one processor, a second video based on the first marking layer and the second marking layer.

### BACKGROUND

### Technical Field

The present disclosure relates to electronic devices in general, and more particularly, to an automated image editing system.

### Description of the Related Art

Law enforcement agencies often share surveillance videos with the public to help solve crimes by identifying suspects depicted in the videos. Ideally, only relevant information need be disclosed while irrelevant or private information is masked or obscured. Moreover, it may be legally required to mask some information from view because these videos often contain personally identifiable information of bystanders that need to be obscured prior to publicly sharing the videos. Such information may include, for example, a face, a tattoo or a license plate. Currently, available solutions are very costly and time-consuming as they require the viewing of hours of footage by a professional video editor and painstakingly blurring selected content on a frame-by-frame basis. Accordingly, the need exists for a more automated and less cumbersome solution for “redacting” irrelevant or personal information from footage so that time and money can be saved.

### SUMMARY

The present disclosure addresses this identified need. According to aspects of the disclosure, a method is provided comprising: (1) converting a first full-motion video (FMV) file into a plurality of video frames associated with the “frame rate” recording of the video file (i.e. 30 frames per second); (2) detecting a first input, and then selecting and tracking a first object in the first plurality of video frames; (2) detecting a second input, and then selecting and tracking a second object in the first plurality of video frames (etc.) (3) generating a first marking layer based on the first input and the first plurality of frames, the first marking layer being associated with the first object; (4) generating a second marking layer based on the second input and the first plurality of frames, the second marking layer being associated with the second object (etc.); and (5) generating, by at least one processor, a second (now altered—redacted) full motion video based on the marking layers identified with each of the selected and tracked objects.

According to aspects of the disclosure, an electronic device is provided comprising a memory and at least one processor coupled to the memory, wherein the at least one processor is configured to: detect a first input selecting and tracking a first object in a first plurality of frames; detect a second input selecting and tracking a second object in the first pluralities of frames (etc.); generate a first marking layer based on the first input and the first plurality of frames, the first marking layer being associated with the first object; generate a second marking layer based on the second input and the first plurality of frames, the second marking layer being associated with the second object; and generate a second (now altered—redacted) full-motion video based on the marking layers identified with each of the selected and tracked objects.

### BRIEF DESCRIPTION OF THE DRAWINGS

A further understanding of the present disclosure can be obtained by reference to a preferred embodiment set forth in the illustrations of the accompanying drawings. Although the illustrated preferred embodiment is merely exemplary of methods, structures and compositions for carrying out the present disclosure, both the organization and method of the disclosure, in general, together with further objectives and advantages thereof, may be more easily understood by reference to the drawings and the following description. The drawings are not intended to limit the scope of this disclosure, which is set forth with particularity in the claims as appended or as subsequently amended, but merely to clarify and exemplify the disclosure.

For a more complete understanding of the present disclosure, reference is now made to the following drawings in which:

FIG. 1 is a diagram of an example of a system, according to aspects of the disclosure;

FIG. 2 is a diagram of an example of an electronic device, according to aspects of the disclosure;

FIG. 3 is a flowchart of an example of a process, according to aspects of the disclosure;

FIG. 4A is a flowchart of an example of a process associated with the process of FIG. 3, according to aspects of the disclosure;

FIG. 4B is a diagram illustrating the operation of the process of FIG. 4A, according to aspects of the disclosure;

FIG. 4C is a diagram illustrating the operation of the process of FIG. 4A, according to aspects of the disclosure;

FIG. 4D is a diagram illustrating the operation of the process of FIG. 4A, according to aspects of the disclosure;

FIG. 4E is a flowchart of an example of a process associated with the process of FIG. 3, according to aspects of the disclosure;

FIG. 4F is a flowchart of an example of a process associated with the process of FIG. 3, according to aspects of the disclosure;

FIG. 4G is a flowchart of an example of a process associated with the process of FIG. 3, according to aspects of the disclosure;

FIG. 5 is a diagram of an example of an interface, according to aspects of the disclosure;

FIG. 6 is a diagram of an example of an interface, according to aspects of the disclosure;

FIG. 7 is a diagram of an example of an interface, according to aspects of the disclosure; and

FIG. 8 is a diagram of an example of an interface, according to aspects of the disclosure.

### DETAILED DESCRIPTION

According to aspects of the disclosure, a video image editing system is disclosed that permits the user to mark objects that appear in a plurality of video frames created from the original full motion video. In operation, the system may identify the location of a selected object in the plurality of frames and mark the object. For example, the system may draw a circle around the object. In addition, the system may apply a particular effect to the object. For example, the system may blur out the object, add a glowing effect to the object, etc.

In some aspects, the system may be used to sanitize sensitive information identified in the original video. For example, the system may blur out the faces of one or more people in order to maintain their privacy. Similarly, the system may be used to blur out other objects that appeared in the original video in order to prevent the objects from being viewed.

In some aspects, the system may be used to provide a video feed in a virtual collaboration environment. More particularly, the virtual collaboration environment may be a platform which permits users to communicate in real-time (e.g., via voice, videoconference or text) and view the same content (e.g., video, images sequences, documents, etc.). In some ways, the virtual collaboration environment may improve worker productivity by providing an alternative to in-person meetings. An example of a virtual collaboration environment is disclosed in U.S. application Ser. No. 14/740,638 which is hereby incorporated by reference.

In some aspects, the system may stream a differently edited version of a video to each of a plurality of participants in a virtual collaboration session. For example, the system may provide to a first user a copy of the video in which an object is blurred out while providing another user with another copy of the video in which the object is visible. In some implementations, the system may determine the degree to which the video needs to be sanitized for each user based on a credential of that user. Each video copy is saved as its own video file. The credential may identify a security clearance of the user and or any other suitable type of authentication information which indicates whether the user is permitted to view a particular type of information that is present in the video, such as a face, a tattoo, a license plate, etc.

As required, a detailed illustrative embodiment of the present disclosure is disclosed herein. However, techniques, systems, compositions and operating structures in accordance with the present disclosure may be embodied in a wide variety of sizes, shapes, forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present disclosure.

Reference will now be made in detail to several embodiments of the disclosure that are illustrated in the accompanying drawings. Wherever possible, same or similar reference numerals are used in the drawings and the description to refer to the same or like parts or steps.

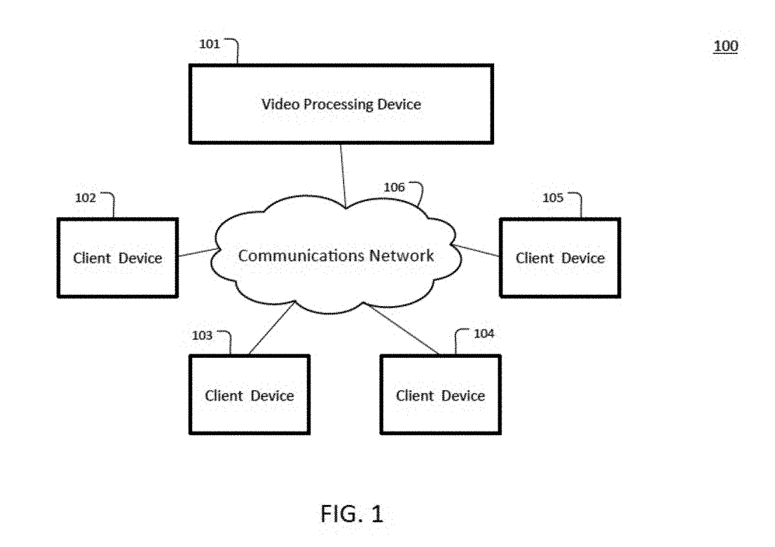

FIG. 1 is a diagram of an example of a system 100, according to aspects of the disclosure. As illustrated, the system 100 includes a video processing device 101, client devices 102-105, and a communications network 106.

According to aspects of the disclosure, the video processing device 101 may be any suitable type of computing device (or system) that is capable of processing video in order to first create a plurality of video frames (images) and then to identify the location of one or more selected objects in the plurality of frames. After finding the location of each of the objects, the video processing device 101 may produce a new edited video in which the marking and/or blurring out the selected objects are able to be viewed. The edited video may then be presented on the video processing device 101 and/or provided for presentation to any of the client devices 102-105 over the communications network 106. Although in the present example, the video processing device 101 is depicted as a monolithic device, in some implementations the video processing device 101 may include a plurality of servers and/or other equipment.

The client devices 102-105 may include any suitable type of computing device. For example, any of the client devices 102-105 may include a smartphone, a desktop computer, a laptop, a gaming console, a digital media player, etc. The communications network 106 may include one or more of a local area network (LAN), a wide area network (WAN), a wireless network (e.g., 802.11, 4G, etc.), and/or any other suitable type of network.

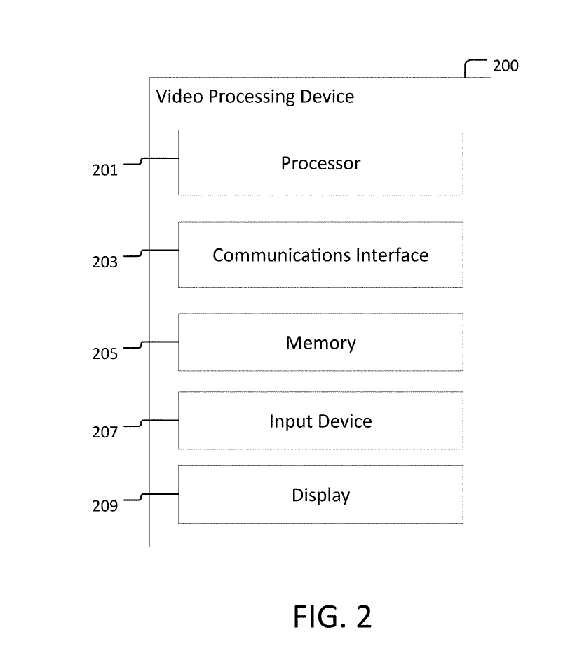

FIG. 2 is a diagram of an example of a client device 200, according to aspects of the disclosure. As illustrated, the client device 200 includes a processor 201, a communications interface 203, a memory 205, an input device 207, and a display 209. According to aspects of the disclosure, the processor 201 may include any suitable type of processing circuitry, such as a general-purpose processor (e.g., an ARM-based processor), an application-specific integrated circuit (ASIC), or a Field-Programmable Gate Array (FPGA). The communications interface 203 may include any suitable type of communications interface, such as a WiFi interface, an Ethernet interface, a Long-Term Evolution (LTE) interface, a Bluetooth Interface, an Infrared interface, etc. The memory 205 may include any suitable type of volatile and non-volatile memory, such as random-access memory (RAM), read-only memory (ROM), flash memory, cloud storage, or network accessible storage (NAS), etc. The input device 207 may include any suitable type of input device, such as a capacitive or resistive touch panel, a keyboard, or a mouse, for example. The display 209 may include any suitable type of display such as a liquid crystal display (LCD), a light-emitting diode (LED) display, or an active-matrix organic light-emitting diode (AMOLED) display. In some implementations, the touch panel 207 may be layered onto the display 209 to form a touchscreen. Although not shown, the client device 200 may include additional (or alternative) input devices, such as a microphone, a keyboard, a mouse, etc.

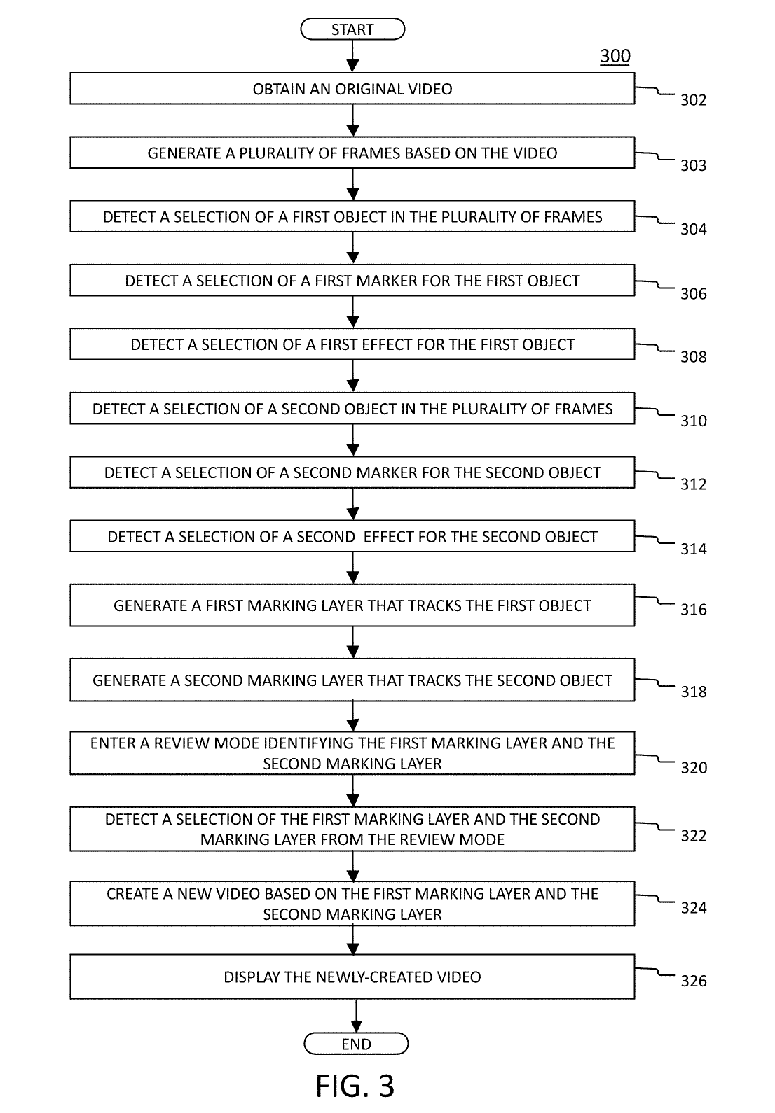

FIG. 3 is a flowchart of an example of a process 300, according to aspects of the disclosure. In some implementations, the process may be executed by an electronic device, such as the video processing device 101. Additionally or alternatively, in some implementations, the process may be executed in a distributed fashion by a plurality of electronic devices, such as the video processing device 101 and at least one other client device.

At task 302, an original video is obtained. According to aspects of the disclosure, obtaining the new video may include capturing the original video with a camera, receiving the original video over a communications network, streaming the original video over the communications network, or retrieving the original video from a memory.

At task 303, the original video is converted into a separate plurality of video frames that correlate with the frame rate at which the original video was recorded. As an example, an original video that has captured at a rate of thirty (30) frames per second would create an equal number of frames to be used for editing in the subsequent series of tasks. Although in the present example the plurality of video frames includes all frames in the video, in some implementations the plurality of video frames may include a portion of all frames in the video. For example, the plurality of video frames may include all frames in a particular segment of the video, or every n^{th} frame of the video (e.g., every 5^{th} frame), etc. According to aspects of the disclosure, each of the frames may be saved as a separate image file (e.g., a .png file) and/or the plurality of frames may be integrated together in the same file and/or data structure. Although in the present example a plurality of video frames is generated, in some implementations a copy of the original video and/or a copy of a portion of the original video may be made to be modified later based on different marking layers that are subsequently generated.

At task 304, a selection of a first object in the created plurality of frames is detected. The first object may be the face of a person that appears in the original video and/or any other object that appears in the original video, such as a license plate. In some implementations, the selection of the first object may be performed by using a mouse, a microphone, a touchscreen, a keyboard and/or any other suitable type of input device. For example, the selection may be performed by clicking on the object with a mouse, touching the object with a stylus or a user's finger, drawing a shape around the object, and/or dragging an object marker onto the object. In some implementations, detecting the selection of the first object may include receiving, over a communications network, a message indicating that the first object is selected.

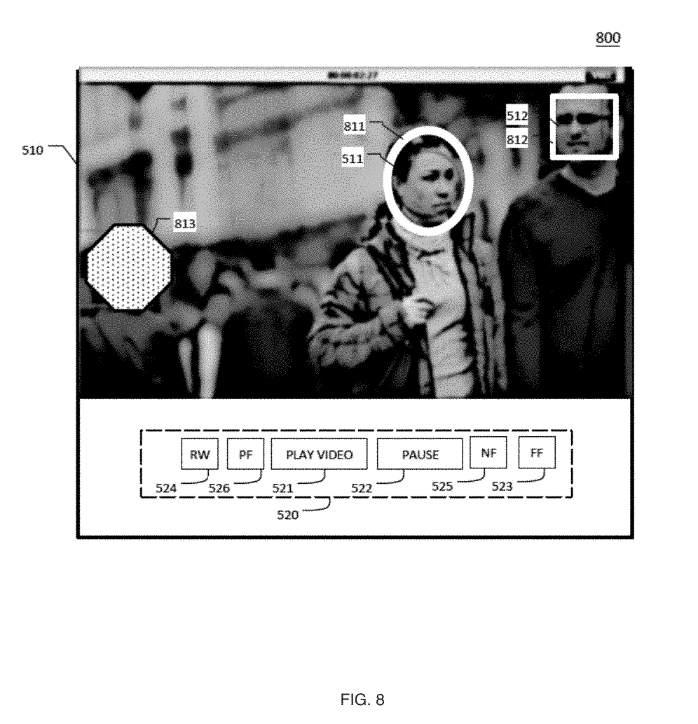

At task 306, a selection of a first object marker for the first object is detected. The first object marker may be an overlay item that is superimposed on or disposed adjacently to the first object. The first object marker may include a geometric shape, an image, text, and/or any other suitable type of content. In some implementations, the first object marker may be an oval that is drawn around the first object, such as the object marker 811 shown in FIG. 8. In some implementations, detecting the selection of the first object marker may include receiving, over a communications network, a message indicating that the first object marker is selected.

At task 308, a selection of a first effect for the first object is detected. The first effect may include any suitable type of effect for obscuring or accentuating the first object. For example, the first effect may include a blurring effect for privacy masking (e.g., blurring out) the object or a glowing effect for adding a glow the object. In some implementations, detecting the selection of the first effect may include receiving, over a communications network, a message indicating that the first effect is selected.

At task 310, a selection of a second object in the plurality of video frames is detected. The second object may be the face of another person that appears in the original video and/or any other item that appears in the original video, such as a license plate. The selection of the second object may be performed by using a mouse, a microphone, a touchscreen, a keyboard and/or any other suitable type of input device. For example, the selection may be performed by clicking on the object with a mouse, touching the object with a stylus or a user's finger, drawing a shape around the object, and/or dragging an object marker onto the object. In some implementations, detecting the selection of the second object may include receiving, over a communications network, a message indicating that the second object is selected.

At task 312, a selection of a second object marker for the second object is detected. The second object marker may be an overlay item that is superimposed on or disposed adjacently to the second object. The second object marker may include a geometric shape, an image, text, and/or any other suitable type of content. In some implementations, the second object marker may be a rectangle that is drawn around the second object, such as the object marker 812 shown in FIG. 8. In some implementations, detecting the selection of the second object marker may include receiving, over a communications network, a message indicating that the second object marker is selected.

At task 314, a selection of a second effect for the second object marker is detected. The second effect may include any suitable type of effect for obscuring or accentuating the second object. For example, the first effect may include a blurring effect for blurring out the object or a glowing effect for adding a glow the object. In some implementations, detecting the selection of the second effect may include receiving, over a communications network, a message indicating that the second effect is selected.

At task 316, a first marking layer for marking the position of the first object is generated. In some implementations, the first marking layer may include a data structure that contains information that is used for marking the first object in the plurality of video frames. In some implementations, the first marking layer may include a plurality of coordinates, wherein each coordinate identifies the location of the first object in a different respective frame of the original video. As is further discussed below, the coordinates may be used to mark the object in the coordinate's respective video frames. Additionally or alternatively, the first marking layer may include a series of masks, wherein each mask is associated with a different frame from the original video. When a given mask from the first marking layer is applied to the mask's corresponding video frame, the first object marker may be drawn on the video frame at a predetermined location associated with the first object (e.g., around the first object).

At task 318, a second marking layer for marking the position of the second object is generated. In some implementations, the second marking layer may include a data structure that contains information that is used for marking the second object identified in the original video. In some implementations, the second marking layer may include a plurality of coordinates, wherein each coordinate identifies the location of the second object in a different respective frame of the original video. As is further discussed below, the coordinates may be used to mark the object in the coordinate's respective video frames. Additionally or alternatively, the second marking layer may include a series of masks, wherein each mask is associated with a different frame from the original video. When a given mask from the second marking layer is applied to the mask's corresponding video frame, the second object marker may be drawn on the video frame at a predetermined location associated with the second object (e.g., around the second object).

At task 320, a review menu is displayed that allows for the review and alteration of any frame located on the first marking layer and the second marking layer. The review mode may include one or more graphical user interface components that identify and/or permit selection of any of the first marking layer and the second marking layer. The menu may include a list, a drop down list, a checkbox list, a radio button list, and/or any other suitable type of graphical user interface component.

At task 322, a selection of one or more marking layers from the review mode menu is selected. In the present example, both the first marking layer and the second marking layer are selected.

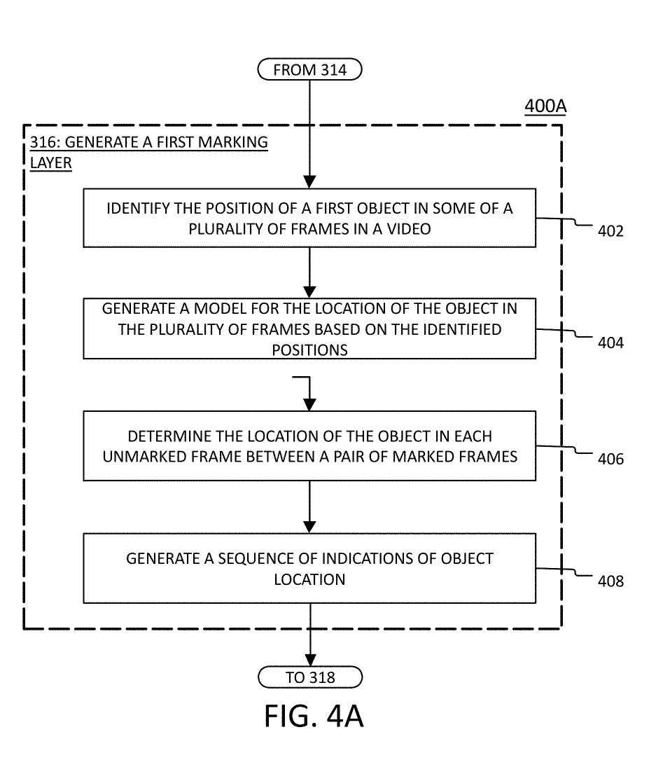

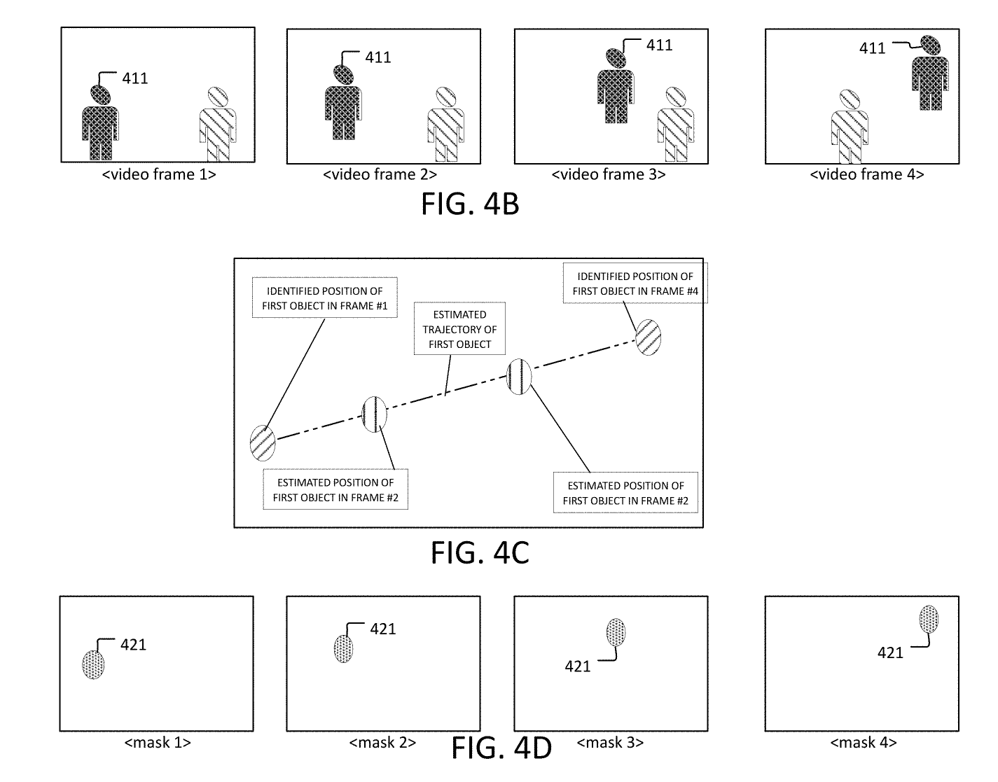

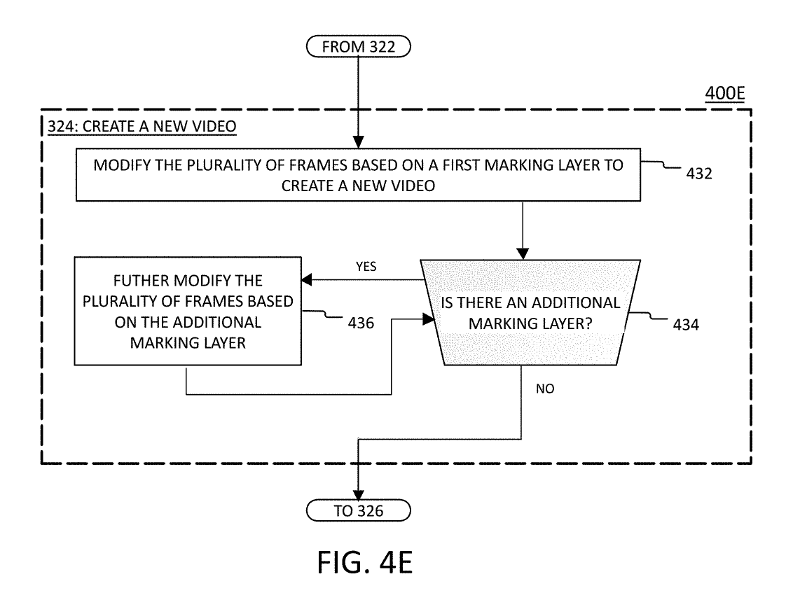

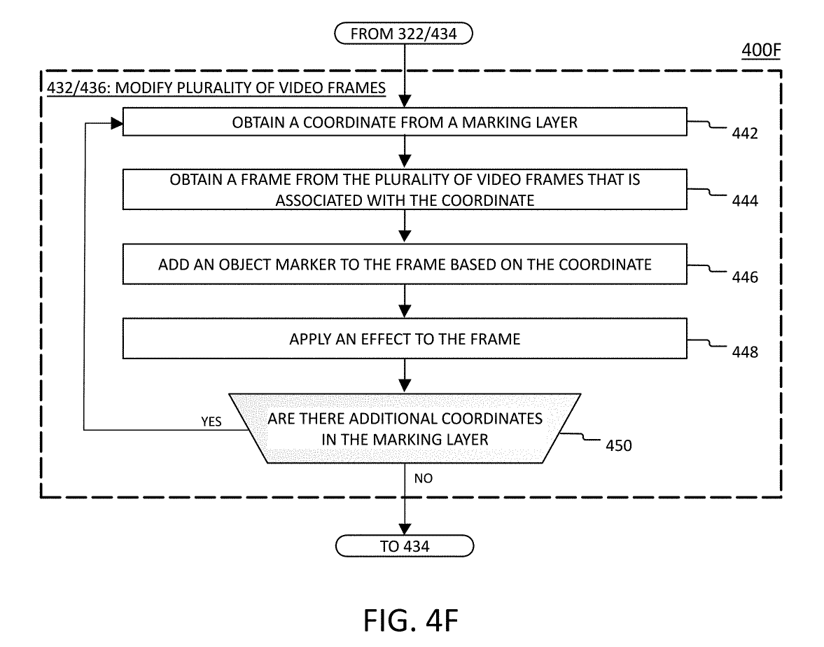

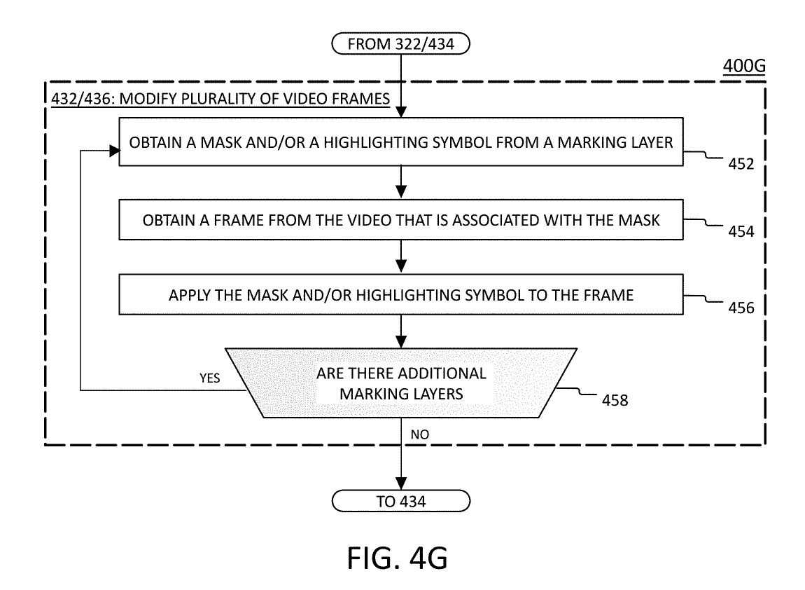

At task 324, a new edited video is generated based on the layers selected from the review mode menu. The edited video is a new and altered version of the original video in which the first object is marked with the first object marker and the second object is marked with the second object marker. The edited video may be generated by reassembling the plurality of video frames into a full motion video that also include the first marking layer and the second marking layer created in the manner discussed with respect to FIG. 4E.

At task 326, the new edited full motion video is displayed. In some implementations, displaying the edited video may include presenting the video on an output device (e.g., an LED display). Additionally or alternatively, displaying the video may include transmitting or streaming the edited video to a client device for display on the client device.

FIG. 4A is a flowchart of a process 400A for generating a marking layer, according to aspects of the disclosure. FIGS. 4B through 4D are schematic diagrams illustrating the operation of the process 400A.

At task 402, the position of the first object in some of a plurality of frames of the original video is identified. According to the example of FIG. 4B, the first object may be the face of a person 411 that appears in the original video. As illustrated, the plurality of frames may include video frame 1, video frame 2, video frame 3, and video frame 4. As illustrated, the location of the face of the person 411 (e.g., the first object) changes in each of these frames. In the present example, the position of the first object is identified in video frame 1 and video frame 4. In some implementations, the position of the object in frames 1 and 4 may be identified automatically, by using any suitable type of image recognition technique. Additionally, or alternatively, in some implementations, the position of the first object in frames 1 and 4 may be identified manually by the user. For example, to identify the first object, the user may place an oval around the face of the person 411 in video frame 1 and video frame 4.

At task 404, a model is generated for the location of the first object in the plurality of frames. The model may be generated based on the position of the object in video frame 1 and video frame 4. As illustrated in FIG. 4C, the model may identify the trajectory traveled by the first object in the video screen when the original video is played. For example, the model may indicate that the object travels across the video screen along a particular straight line.

At task 406, the location of the first object in each of the remaining frames in the plurality is estimated based on the model. As illustrated in FIG. 4C, the location of the first object in video frame 2 and video frame 3 may be determined based on the trajectory of the object from Frame 1 to Frame 4.

At task 408, a sequence of masks is generated based on the location of the object in each of the plurality of frames. As illustrated in FIG. 4D, each mask may include an image having a transparent background and a first object marker 421 disposed at a location in the mask that it is determined based on the location of the first object in a corresponding frame in the original video. For example, the first object marker 421 may be disposed in mask 1 at the same location as the first object (i.e., the face of person 411) in the video frame 1. As another example, the first object marker 421 may be disposed in mask 2 at the same location as the first object (i.e., the face of person 411) in the video frame 2. As yet another example, the first object marker 421 may be disposed in mask 3 at the same location as the first object (i.e., the face of person 411) in the video frame 3. As yet another example, the first object marker 421 may be disposed in mask 4 at the same location as the first object (i.e., the face of person 411) in the video frame 4. Stated succinctly, each of the masks may correspond to a different one of the plurality of video frames and it may include the first object marker disposed at the same location as the first object in the mask's corresponding frame from the original video.

In some implementations, the masks may be used to generate a new edited video in which the first object is marked. For example, when each of the masks is superimposed over that mask's corresponding video frame, the first object in the video frame may be marked as a result of the first object marker becoming superimposed on the object. For example, when video frame 1 is merged with mask 1, a new edited frame may be generated in which the first object marker 421 is superimposed on the face of the person 411 in video frame 1. Similarly, when mask 4 is merged with video frame 4, a new edited frame may be generated in which the first object marker 421 is superimposed on the face of the person 411 in video frame 4. As can be readily appreciated, masks corresponding to additional objects may be merged with the new edited frames in the same manner in order to cause the additional objects to also be marked in the newly created video.

Although in the present example the object location model is generated based on the location of the first object in two frames only, in some implementations the object location model may be generated based on the object's location in any number of frames (e.g., 3, 5, 15, 500, etc.). Although in the present example, the estimated trajectory of the object is a curved line, it should be noted that the estimated trajectory may have any suitable shape. For example, the estimated trajectory may be a straight line, a curved line, an oval, etc. Although in the present example the location of the first object in some frames is determined based on an object location model, in some implementations any suitable type of image recognition technique may be used instead. Although in the present example all frames of the video are presumed to include the first object, it is to be understood that the first object may not be present in some frames of the video. In such instances, any suitable type of image recognition technique and/or user input may be used to confirm whether the first object is present in a particular frame of the original video.

FIG. 4E is a flowchart of an example of a process 400E for generating an edited video as discussed with respect to task 324 of FIG. 3. At task 432, the plurality of video frames created from the original video are modified based on a first marking layer to produce a modified video. At task 434 a determination is made if there is an additional marking layer that needs to be applied. If there is an additional marking layer that needs to be applied, at task 436, the plurality of video frames is further modified based on additional marking layer. If there are no additional marking layers that need to be applied, the process returns to task 326.

FIG. 4F is a flowchart of an example of a process 400F for applying a marking layer to a system created plurality of video frames, as discussed with respect to tasks 432 and 436 of FIG. 4E. The plurality of video frames may be those from the original video or a modified plurality of video frames to which one or more marking layers have been applied already. In the present example, the marking layer may be a data structure that includes a sequence of coordinates associated with a given object in the created plurality of frames (e.g., the first object or the second object). In addition, the marking layer may include an indication of an object marker that is to be used to mark the given object and an effect that is to be applied.

At task 442, a coordinate from the marking layer is obtained. At task 444, a frame from the plurality of video frames that is associated with the coordinate is obtained. At task 446, the object marker associated with the marking layer is drawn on the frame. For example, the object marker may be drawn at exactly the same location that is identified by the coordinate or another location that is determined based on the coordinate. At task 448, an effect associated with the marking layer is applied to the frame. In some implementations, the effect may be applied to the object marker and/or the object associated with the marking layer. For example, when the object marker is an oval surrounding the first object, the effect may be applied to the portion of the frame that is located in the interior of the oval, thereby causing the appearance of the first object to be modified (e.g., obscured). At task 450, a determination is made whether there are additional coordinates in the marking layer that remain to be processed. If there are additional coordinates, the process returns to task 442. If there are no additional coordinates, the process returns to task 434.

Although in the present example each of the coordinates in the marking layer is associated with only one frame of the original video, in some implementations any of the coordinates may be associated with multiple frames from the video. Additionally or alternatively, in some implementations, each of the frames created from the original video may be associated with only one coordinate.

FIG. 4G is a flowchart of an example of a process 400G for applying a marking layer to the plurality of video frames, as discussed with respect to tasks 432 and 436 of FIG. 4E. The plurality of video frames may be those created from the original video that are not yet modified or to the plurality of already modified video frames to which one or more marking layers have been applied already. In the present example, the marking layer may be a series of masks, and it may be associated with a particular object (e.g., the first object or the second object).

At task 452, a mask and/or a highlighting symbol is obtained from the marking layer. At task 454, a frame that is associated with the mask and/or masking symbol is obtained from the plurality of video frames. At task 456, the mask and/or highlighting symbol is applied to the frame. According to aspects of the disclosure, applying the mask and/or highlighting symbol to the frame may cause the object associated with the marking layer to be marked. For example, applying the mask to the frame may cause an object marker to be drawn around the object or adjacently to the object. Additionally or alternatively, applying the mask to the frame may cause an effect associated with the marking layer to be imparted on the frame. For example, applying the mask to the frame may cause the object to be blurred out or otherwise changed. Additionally or alternatively, applying the highlighting symbol may cause a symbol (e.g., an alphanumerical symbol) to be displayed over or adjacently to the object. At task 458, a determination is made whether there are additional masks in the marking layer that remain to be processed. If there are additional masks, the process returns to task 452. If there are no additional masks, the process returns to task 434.

Although in the present example, each of the masks in the marking layer is associated with only one frame of the plurality of video frames, in some implementations any of the masks may be associated with multiple frames. Additionally or alternatively, in some implementations, each of the frames created from the original video may be associated with only one mask.

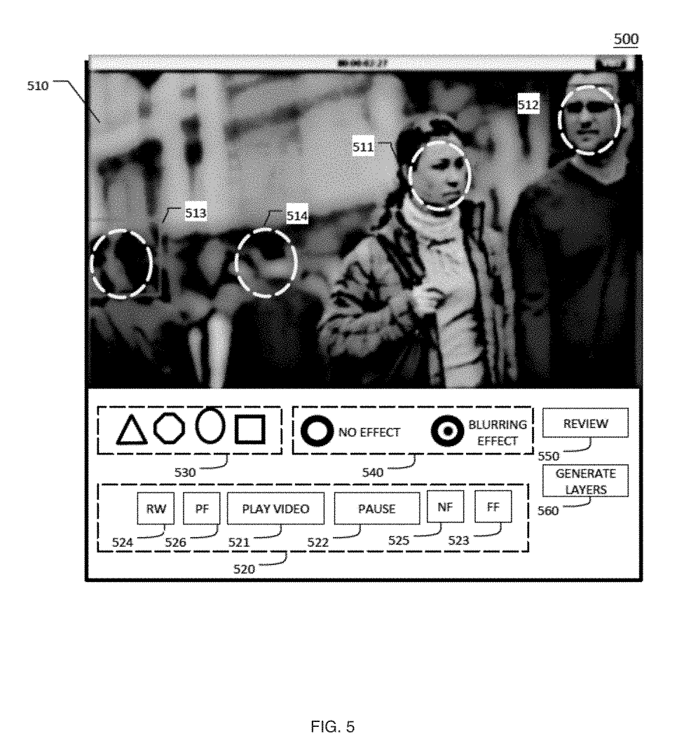

FIG. 5 is a diagram of an interface 500 for selecting one or more frames from the plurality of video frames, according to aspects of the disclosure. As illustrated, the interface includes a frame-based player window 510, a control menu 520, an object marker menu 530, an effects menu 540, a review button 550, and a generate layers button 560.

The video player window 510 may be used to produce a frame-by-frame view of an original video. In the present example, the video player window 510 displays a still frame from the plurality of frames created from an original video that includes footage of a street with a number of people walking on it. Present in the frame is a first object 511 which includes the face of a first person, a second object 512 which includes the face of a second person, a third object 513 which includes the head of a third person, and fourth object 514 which includes the head of a fourth person.

The control menu 520 may include one or more buttons for controlling playback of the plurality of video frames created from the original video. For example, the control menu 520 may include a play button 521 for viewing the plurality of video frames at the same rate as the recording of the original video (i.e. 30 frames per second), a pause button 522 for stopping the frame-based player window at a particular video frame, a fast forward button 523 for fast forwarding through the plurality of video frames, a rewind button 524 for advancing backwards through the video frames. The control menu 520 may further include a next frame button 525, which when pressed causes the electronic device displaying the interface 500 to present the next frame from with the plurality of video frames (i.e., the frame that comes next after the frame that is currently displayed) in the frame-based player window 510. In addition, the control menu 520 may further include a previous frame button 526, which when pressed causes the electronic device displaying the interface 500 to present the previous frame from within the plurality of video frames created from the original video (i.e., the frame that comes before the frame that is currently displayed).

The object marker menu 530 permits the selection of one or more object markers for marking any of the objects 511-514. In the present example, the object markers include a triangle shape, an octagon shape, an oval shape, and a square shape. The effects menu 540 may permit the association of respective effects with the objects 511-514.

When the interface 500 is displayed, the user may position the first object 511 upon the person or object of interest by selecting the oval shape from the object marker menu 530 and associating the shape with the tracking number that is associated with object 511. In this manner, with a two-step action, the user may first select the first object from the video and then associate the first object with a particular object marker/shape. Furthermore, the first object 511 may be associated with an effect that is currently selected from the effects menu 540 when the first object is identified. Similarly, the user may select the second object 512 by selecting the rectangle from the object marker menu 530 and associating it with the tracking number designated for the second object 512. Furthermore, the user may select the tracking number associated with the third object 513 and then select the octagon symbol from the object marker menu 530 thereby associating it with the third object 513. And still furthermore, the user may select the tracking number associated with the fourth object 514 and then select the triangle from the object marker menu 530, thereby associating it with the fourth object 514.

In some implementations, the user may select any of the objects 511-514 in more than one frame. For example, after selecting the first object from the video frame that is currently displayed in the frame-based player window 510, the user may fast forward the plurality of video frames to another frame. Afterwards, the user may again select the oval from the object marker menu 530 and associate it with the first object 511. As discussed above with respect to FIGS. 4A-D, by identifying the first object 511 in multiple frames of the plurality of video frames, the user may facilitate the creation of an object location model for tracking the first object 511 throughout the entire of the plurality of video frames.

When the review button 550 is pressed, the frame-based player may automatically set the plurality of video frames to frame one and advances the frames at the recording speed of the original video. As the frames advance forward, the user can view each of the selected markers and the exact location of each marker on each of the selected objects 511-514.

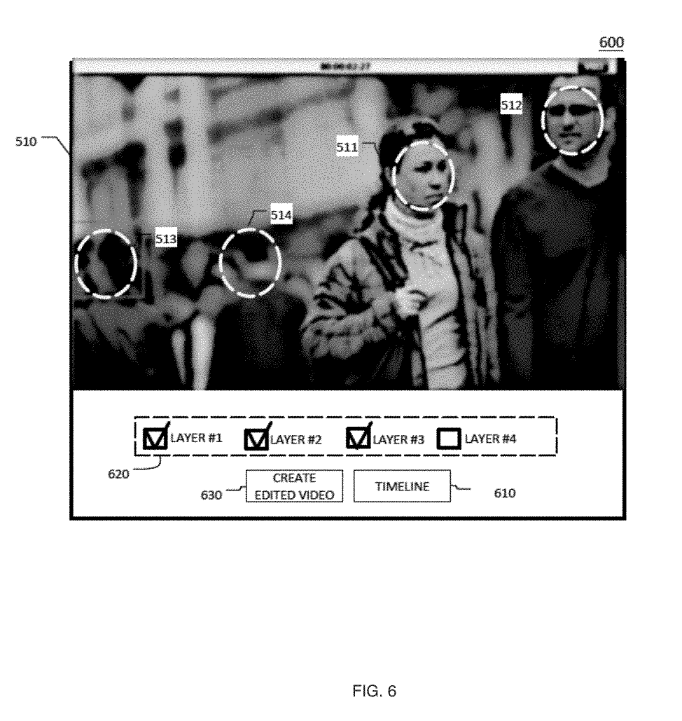

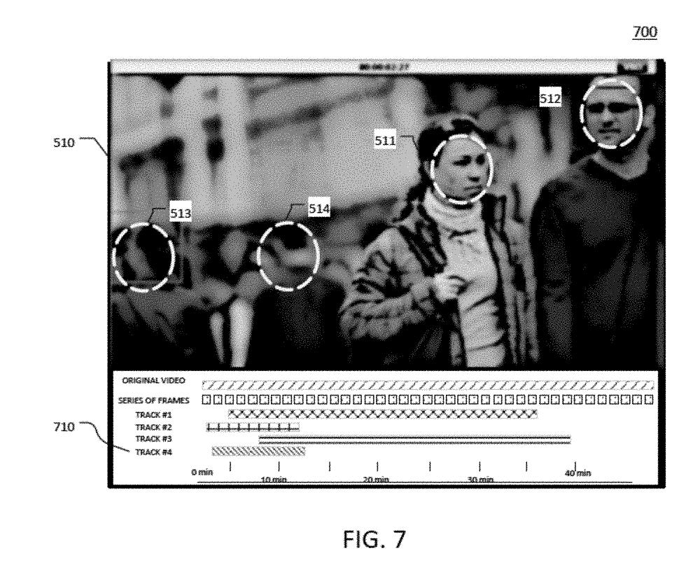

When the timeline button 570 as illustrated in FIG. 6 is pressed, the interface 700, which is illustrated in FIG. 7, may be displayed. The interface 700 may include a timeline 710 which illustrates the temporal overlap between the original video, the plurality of video frames created from the original video and the different marking layers, and the extent to which the marking layers overlap with the original video. As illustrated, each of the marking layers may encompass only a portion of the original video in which the marking layer's respective object appears. For example, the timeline 710 may indicate that the first marking layer provides overlay information for the segment of the original video that starts at minute 5 and ends at minute 35. Similarly, the timeline 710 may indicate that the second marking layer provides overlay information for the segment of the original video that starts minute 2 and ends at minute 8. Stated succinctly, the timeline 710 may provide a visual aid for understanding the relationship between different marking layers and the original video.

Returning to FIG. 6, the marking layer selection menu 620 may identify a plurality of available marking layers and permit the selection of at least some of the layers. In the present example, the first marking layer, the second marking layer, and the third marking layer are selected from the marking layer selection menu 620.

When the create video button 570 is pressed, a new edited full motion video file is generated from the plurality of video frames based on the marking layers that are selected from the marking layer selection menu 530. Upon completion of the full motion video creation process, the interface 800 is displayed. In the present example, the edited full motion video is generated based on the first marking layer, the second marking layer, and the third marking layer. According to aspects of the disclosure, generating the newly edited video may include marking the first object 511 in the plurality of video frames based on the first layer, marking the second object 512 in the plurality of video frames based on the second layer, and marking the third object 513 in the plurality of video frames based the third layer. In the present example, marking any of the objects 511-513 may include placing the object's respective object marker on or adjacently to the object in at least some of the frames in the plurality of video frames that include the object. Furthermore, marking any of the objects 511-513 may include applying an effect to the object, if such effect is selected. As noted above, applying the effect may include blurring out the object, adding a glow to the object, etc.

FIG. 8 depicts an example of an interface 800 for viewing the resulting edited full motion video, according to aspects of the disclosure. As illustrated, in the example of FIG. 8, the edited video is a new version of the original video in which the objects 511, 512, and 513 are marked based on the objects' respective marking layers. More particularly, in the edited video, the first object 511 is marked by placing the object marker 811 around the first object 511. No additional effects are applied to the first object 511 which permits the first object 511 to remain unobscured. Similarly, in the edited video, the second object 512 is marked by placing the object marker 812 around the second object 512. No additional effects are applied to the second object 512 which permits the second object 512 to remain unobscured. Furthermore, in the edited video, the third object 513 is marked by displaying the object marker 813 around the third object 513. In addition, a blurring effect is applied to the third object 513 in order to prevent the third object 513 from being seen. Although in the present example both an effect (e.g., a blurring effect) and an object marker 813 are applied to the third object 513, in some implementations only the effect may be applied. The effect may be applied within the contours of the object marker 813 or within the contours of the third object 513. According to aspects of the disclosure, the edited video may be generated by placing any of the object markers 811, 812, and 813 in any frame of the plurality of video frames created from the original video that includes the object marker's respective object.

FIGS. 1-8 are provided as examples only. At least some of the tasks discussed with respect to these figures can be performed concurrently, performed in a different order, and/or altogether omitted. It will be understood that the provision of the examples described herein, as well as clauses phrased as “such as,” “e.g.”, “including”, “in some aspects,” “in some implementations,” and the like should not be interpreted as limiting the claimed subject matter to the specific examples.

The above-described aspects of the present disclosure can be implemented in hardware, firmware or via the execution of software or computer code that can be stored in a recording medium such as a CD-ROM, a Digital Versatile Disc (DVD), a magnetic tape, a RAM, a floppy disk, a hard disk, or a magneto-optical disk or computer code downloaded over a network originally stored on a remote recording medium or a non-transitory machine-readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Although some of the above examples are provided in the context of an IP camera and IP stream, it is to be understood that any suitable type of networked camera and/or media stream can be used instead. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”. While the present disclosure has been particularly shown and described with reference to the examples provided therein, it is to be understood by those skilled in the art that various changes in form and details may be made therein without departing from the spirit and scope of the present disclosure as defined by the appended claims.

What is claimed is:

1. A method comprising:
detecting a first input selecting a first object in a first video;
detecting a second input selecting a second object in the first video;
generating a first marking layer based on the first input and the first video, the first marking layer being associated with the first object;
generating a second marking layer based on the second input and the first video, the second marking layer being associated with the second object; and
generating, by at least one processor, a second video based on the first marking layer and the second marking layer.

2. The method of claim 1, further comprising:
providing the second video to a viewer,
wherein the first marking layer includes the editing of pixels in the full motion video for obscuring the first object in the second video, and
wherein the first marking layer is selected for inclusion in the second video based on a credential associated with the viewer indicating that the viewer lacks authorization to view the first object.

3. The method of claim 1, wherein the second video is an edited version of the first video in which the first object and the second object are modified.

4. The method of claim 1, wherein the first object includes a first subject's face and the second object includes a second subject's face.

5. The method of claim 1, wherein the first video includes a plurality of frames, and generating the first marking layer includes identifying a respective location of the first object in any of the plurality of frames.

6. The method of claim 1, wherein:
the first marking layer includes a plurality of indications of object location,
any of the indications of object location identifies a respective location of the first object in one or more frames of the first video, and
any of the indications of object location includes at least one of a coordinate and a mask for marking the first object.

7. The method of claim 1, wherein generating the second video based on the first marking layer and the second marking layer includes combining the first marking layer and the second marking layer.

8. The method of claim 1, wherein the first marking layer is associated with a first duration and the second marking layer is associated with a second duration that is different from the first duration, the method further comprising displaying a menu indicating a temporal overlap between the first marking layer and the second marking layer.

9. The method of claim 1, further comprising:
displaying a review mode identifying the first marking layer and the second marking layer;
detecting a selection of the first marking layer and the second marking layer from any individual frame displayed in the review mode,
wherein the first marking layer and the second marking layer are used as a basis for generating the second video when the first marking layer and the second marking layer are selected from the menu.

10. The method of claim 9, wherein the review mode identifies one or more additional marking layers, such that only some of all marking layers identified in a shapes menu are selected from the menu and used as a basis for generating the second video.

11. An electronic device comprising a memory and at least one processor coupled to the memory, wherein the at least one processor is configured to:
detect a first input selecting a first object in a first video;
detect a second input selecting a second object in the first video;
generate a first marking layer based on the first input and the first video, the first marking layer being associated with the first object;
generate a second marking layer based on the second input and the first video, the second marking layer being associated with the second object; and
generate a second video based on the first marking layer and the second marking layer.

12. The electronic device of claim 11, wherein:
the at least one processor is further configured to provide the second video to a viewer,
the first marking layer includes overlay information for obscuring the first object in the second video, and
the first marking layer is selected for inclusion in the second video based on a credential associated with the viewer indicating that the viewer lacks authorization to view the first object.

13. The electronic device of claim 11, wherein the second video is an edited version of the first video in which the first object and the second object are modified.

14. The electronic device of claim 11, wherein the first object includes a first subject's face and the second object includes a second subject's face.

15. The electronic device of claim 11, wherein the first video includes a plurality of frames, and generating the first marking layer includes identifying a respective location of the first object in any of the plurality of frames.

16. The electronic device of claim 11, wherein:
the first marking layer includes a plurality of indications of object location,
any of the indications of object location identifies a respective location of the first object in one or more frames of the first video, and
any of the indications of object location includes at least one of a coordinate and a mask for marking the first object.

17. The electronic device of claim 11, wherein generating the second video based on the first marking layer and the second marking layer includes combining the first marking layer and the second marking layer.

18. The electronic device of claim 11, wherein:
the first marking layer is associated with a first duration,
the second marking layer is associated with a second duration that is different from the first duration,
and the at least one processor is further configured to display a menu indicating a temporal overlap between the first marking layer and the second marking layer.

19. The electronic device of claim 11, further comprising:
displaying a review mode identifying the first marking layer and the second marking layer; and
detecting a selection of the first marking layer and the second marking layer from the review mode menu,
wherein the first marking layer and the second marking layer are used as a basis for generating the second video when the first marking layer and the second marking layer are selected from the menu.

20. The electronic device of claim 19, wherein the menu identifies one or more additional marking layers, such that only some of all marking layers identified in the menu are selected from the menu and used as a basis for generating the second video.
